(19) United States
(12) Patent Application Publication
(10) Pub. No.: US 2015/0338020 A1
(43) Pub. Date: Nov. 26, 2015

(54) Quick Release Collapsible Sports Board Support Assembly

(71) Applicant: Raymond L. Jesewitz, Longwood, FL (US)

(72) Inventor: Raymond L. Jesewitz, Longwood, FL (US)

(21) Appl. No.: 14/813,540

(22) Filed: Jul. 30, 2015

Related U.S. Application Data
(63) Continuation-in-part of application No. 14/218,947, filed on Mar. 18, 2014.
(60) Provisional application No. 61/802,516, filed on Mar. 16, 2013.

(51) Int. Cl. F16M 13/02

(52) U.S. Cl. CPC F16M 13/022; F16M 13/02

(57) ABSTRACT

A quick release collapsible sports board support assembly for removable attachment to a support structure, which can be mounted onto boats and other support structures, for supporting wake boards, snow boards, surf boards and various other sports boards. The apparatus includes at least one foldable board support fork hingedly attached to the support structure, the fork having prongs extending away from the support structure, where the foldable support fork is folded onto the support structure to minimize the space occupied by the assembly and to minimize the hazards associated with protruding forks. One embodiment includes a rotatable and pivotable support base which, in combination with the ability to fold the board support forks, allows the sports board support assembly to be nearly infinitely repositionable and adjustable and therefore is uniquely compatible with adjustable support structures such as height adjustable towers which change angles as the tower is raised or lowered.

### CROSS REFERENCE TO RELATED APPLICATIONS

This application is a Continuation-In-Part of U.S. patent application Ser. No. 14/218,947, filed Mar. 18, 2014 which claims priority to US Provisional Patent Application 61/802,516, filed Mar. 16, 2013, expired. This application hereby incorporates U.S. patent application Ser. No. 14/218,947 by reference and claims the benefit of thereof.

### BACKGROUND OF THE INVENTION

The invention provides collapsible assembly for supporting wake boards, snow boards, surf boards and various other sports boards.

### SUMMARY OF THE INVENTION

The present invention is a distinctive collapsible sports board support assembly which can be mounted onto boats and other support structures. The collapsible sports board support assembly includes folding forks which can be collapsed or folded to minimize the hazards associated with protruding forks and to minimize the space taken up by the assembly.

### BRIEF DESCRIPTION OF THE DRAWINGS

FIG. 1 shows a collapsible sports board support assembly for wakeboards.

FIG. 2 shows a collapsible sports board support assembly for snowboards.

FIG. 3 shows a collapsible sports board support assembly mounted on a boat.

FIG. 4 shows a collapsible sports board support assembly mounted on a boat.

FIG. 5 shows a collapsible sports board support assembly mounted on a boat.

FIG. 6 shows a sports board being mounted to a collapsible sports board support assembly.

FIG. 7 shows a sports board being mounted to a collapsible sports board support assembly.

FIG. 8 shows a sports board being mounted to a collapsible sports board support assembly.

FIG. 9 shows collapsible sports board support assembly with one folded fork.

FIG. 10 shows a collapsible sports board support assembly as combined with a sports board.

FIG. 11 shows a collapsible sports board support assembly as combined with a sports board with the forks partially folded to accommodate boot and binding.

FIG. 12 shows a collapsible sports board support assembly with a board securing cord.

FIG. 13 shows a collapsible sports board support assembly with a board securing cord.

FIG. 14 shows the fork attachment hinge and fork hinge quick release handle.

FIG. 15 shows a board support mount.

FIG. 16 shows a board support mount.

FIG. 17 shows a board support mount.

FIG. 18 shows a quick release handle and a quick release bolt.

FIG. 19 shows a collapsible sports board support assembly being mounted to a boat support structure.

FIG. 20 shows a supplemental base support mount holder.

FIG. 21 shows the board support base mount rotational section and its companion slot.

FIG. 22 shows a collapsible sports board support assembly mounted to a boat structure with the forks folded (stowed position).

FIG. 23 shows the board support base mount rotational section and its aperture.

FIG. 24 shows a collapsible sports board support assembly mounted to a boat structure with the forks folded and positioned horizontal to the boat deck.

FIG. 25 shows a collapsible sports board support assembly mounted to a boat structure with the forks folded and positioned horizontal to the boat deck.

FIG. 26 shows a collapsible sports board support assembly mounted to a boat structure with the forks folded and positioned at a rotated angle from the boat deck.

FIG. 27 shows a collapsible sports board support assembly mounted to a boat structure with the forks unfolded (board mounting position).

FIG. 28 shows a collapsible sports board support assembly mounted to a boat structure with the forks unfolded (board mounting position).

FIG. 29 shows a support structure mounted to a boat gunwale with an integrated support base.

FIG. 30a shows board forks and hinges in the unfolded position (board mounting position) for mounting to a support base integrated into a support structure.

FIG. 30b shows board forks and hinges with one fork in the folded position and the other fork in the unfolded position.

FIG. 30c shows board forks and hinges in the folded position (stowed position) for mounting to a support base integrated into a support structure.

FIG. 31 shows board forks and hinges in the unfolded position (board mounting position) mounted to an integrated support base as part of a support structure.

FIG. 32 is a perspective view of the collapsible sports board support assembly.

FIG. 33 is a side view of the collapsible sports board support assembly.

FIG. 34 is a top view of the collapsible sports board support assembly without forks attached.

FIG. 35 is a top view of the collapsible sports board support assembly with a single fork attached and folded.

FIG. 36 is a top view of the collapsible sports board support assembly with both forks attached and folded.

FIG. 37 is a partial top view of a fork positioned next to a partial top view of a wing of the support base.

FIG. 38 is a side view of the spline of the board support mount.

FIG. 39 is a rear view of the board support mount.

FIG. 40 is a front view of the board support mount.

FIG. 41 shows a collapsible sports board support assembly mounted on a support structure.

FIG. 42 is a top view providing details of an embodiment of the quick release feature.

FIG. 43 is a side view providing details of an embodiment of the quick release feature.

### DETAILED DESCRIPTION OF THE PREFERRED EMBODIMENT

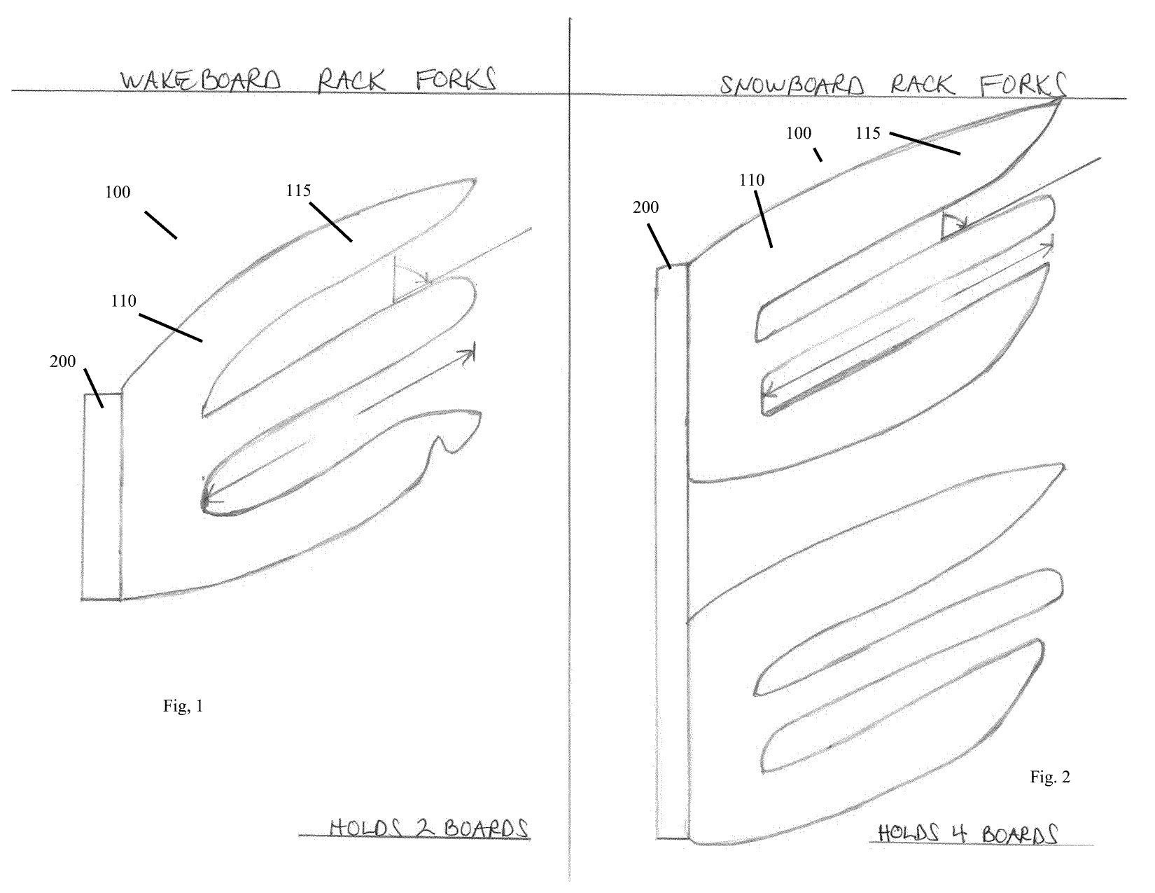

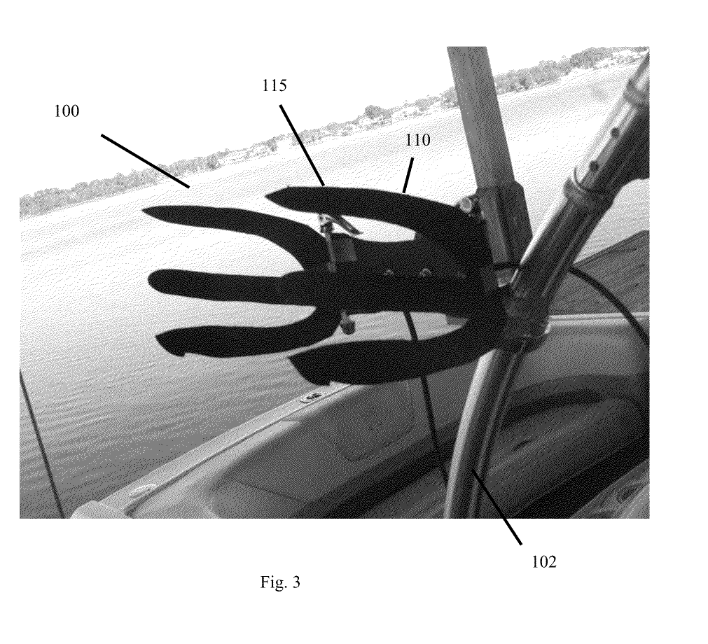

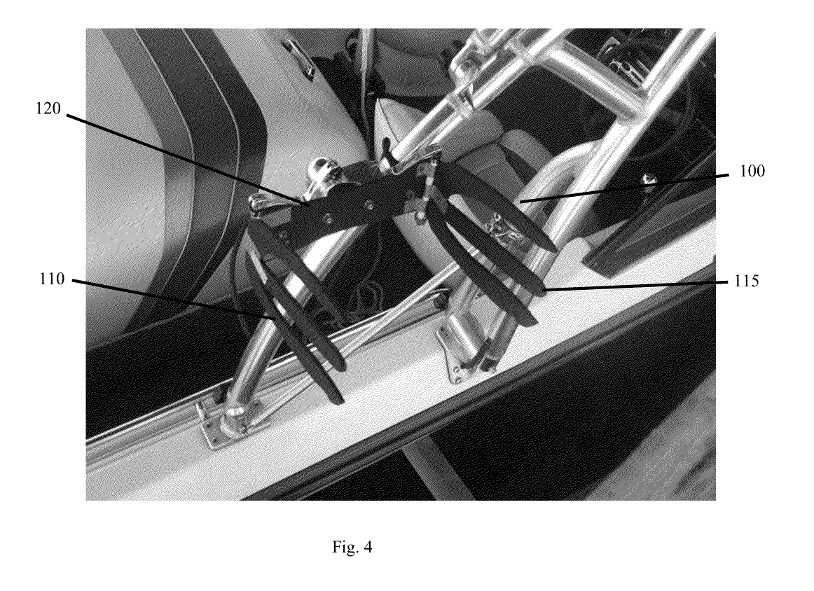

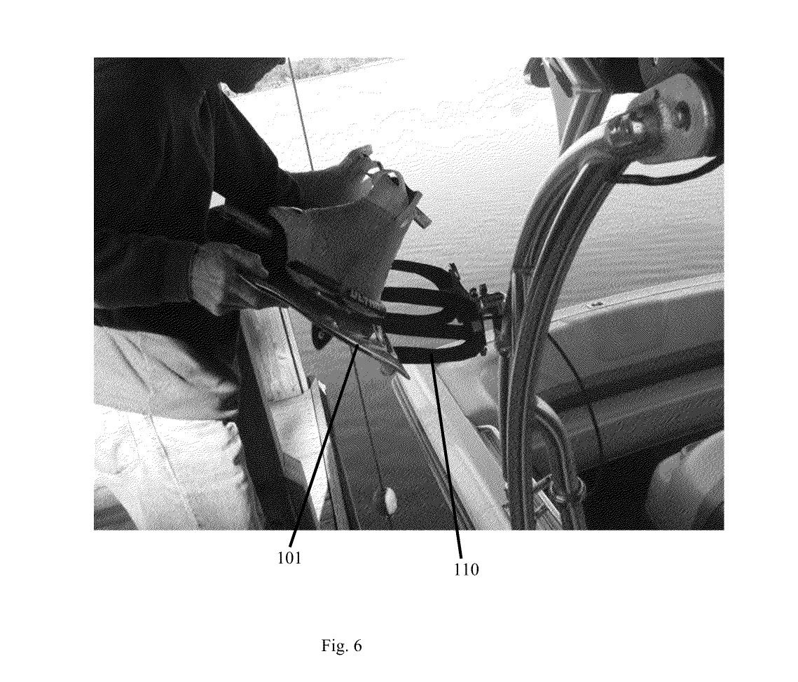

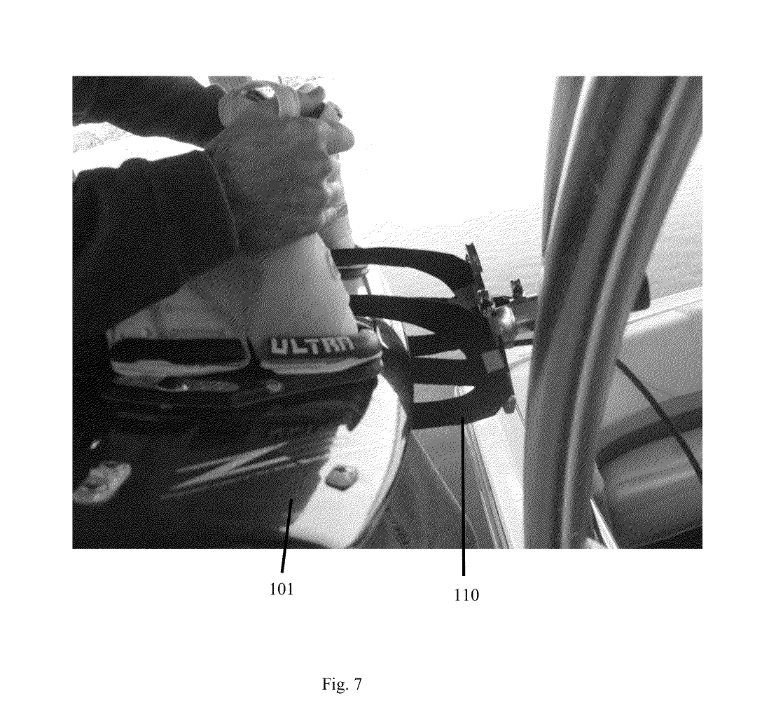

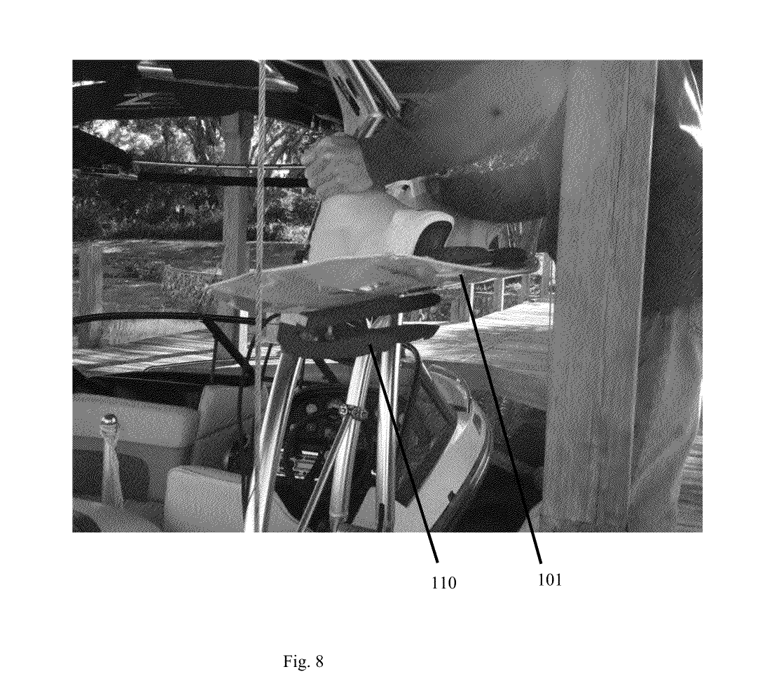

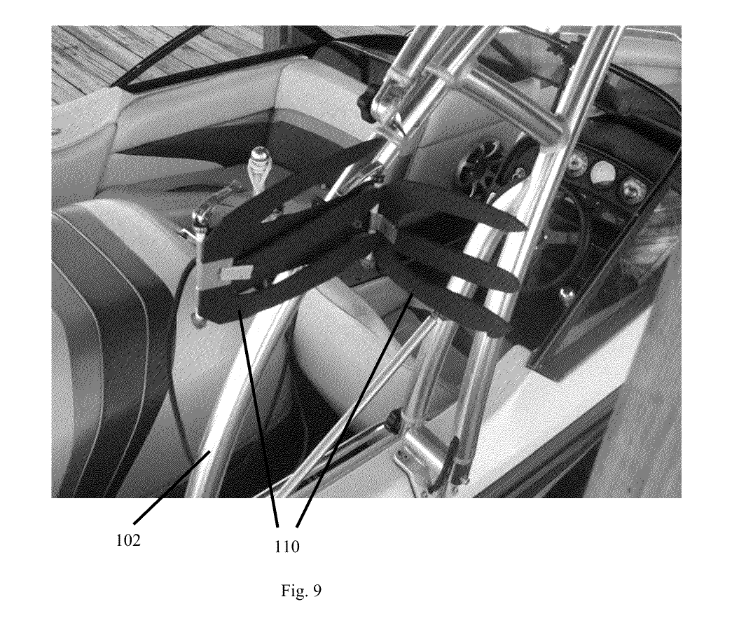

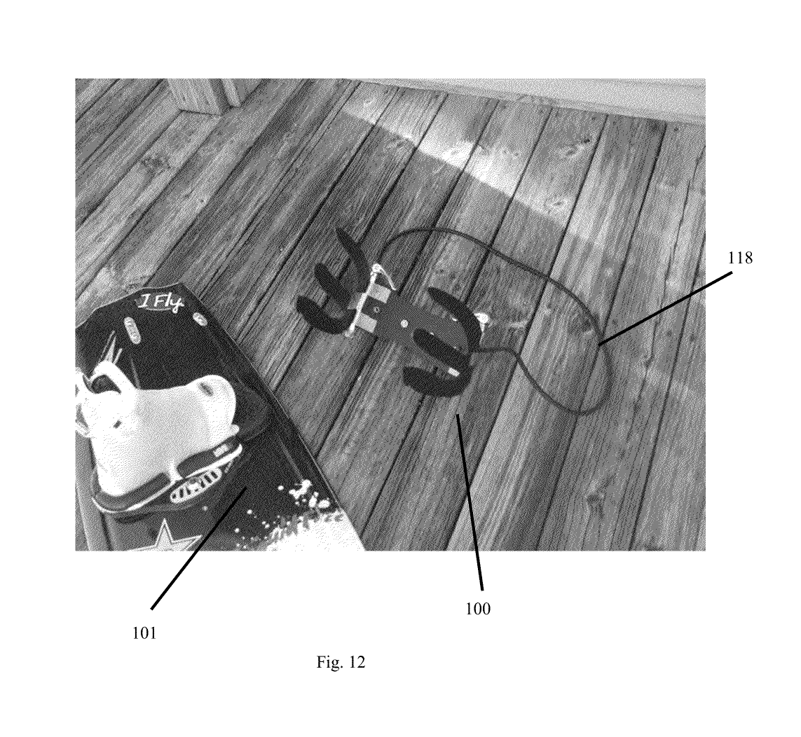

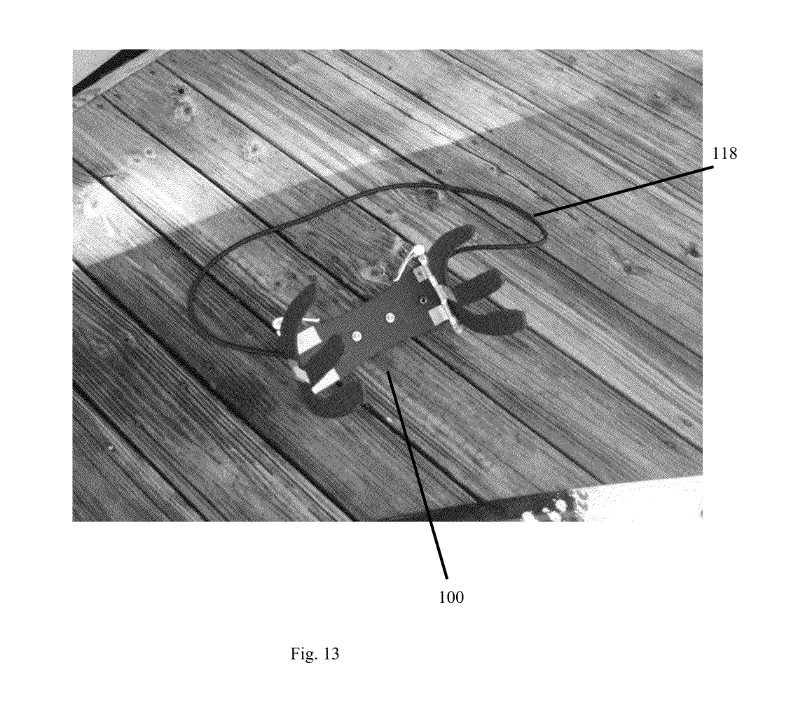

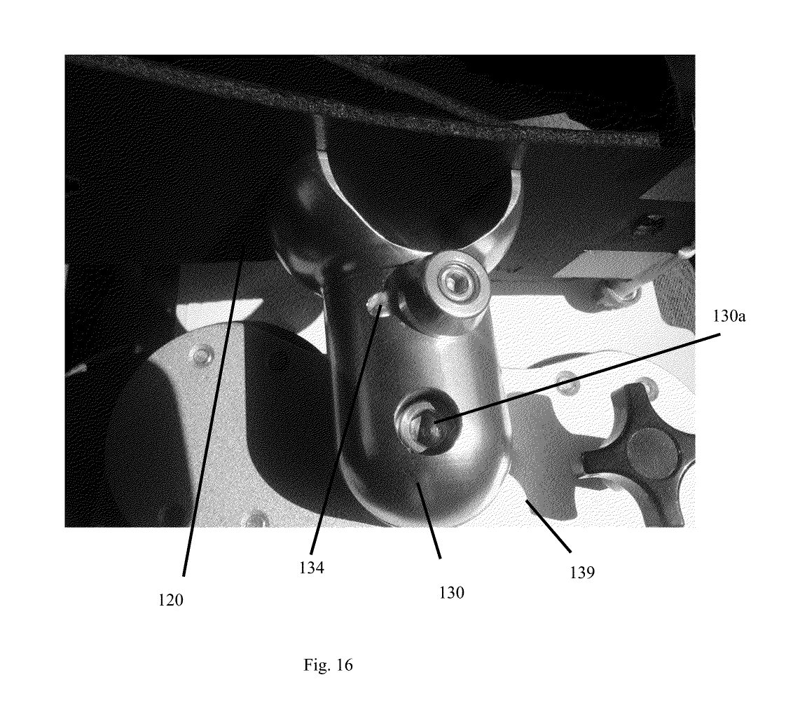

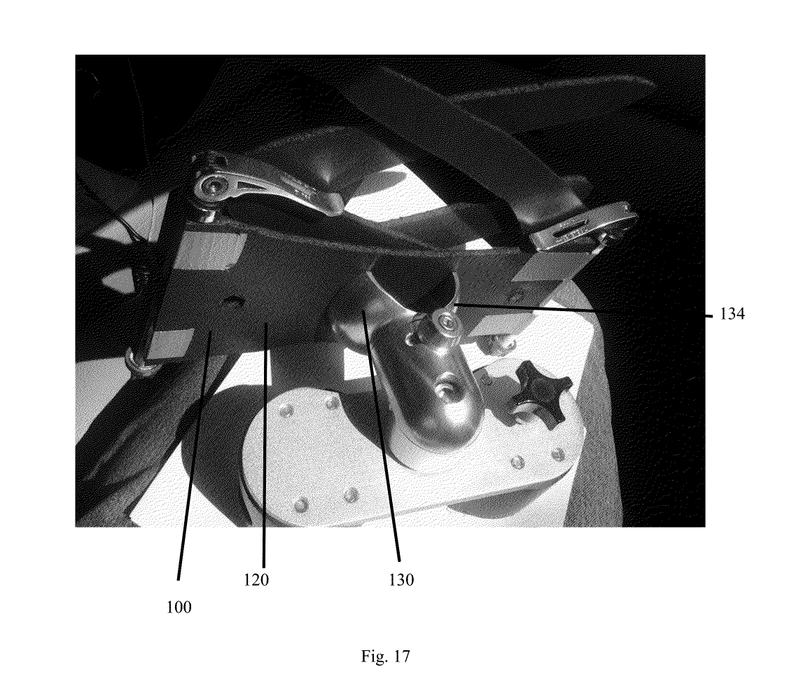

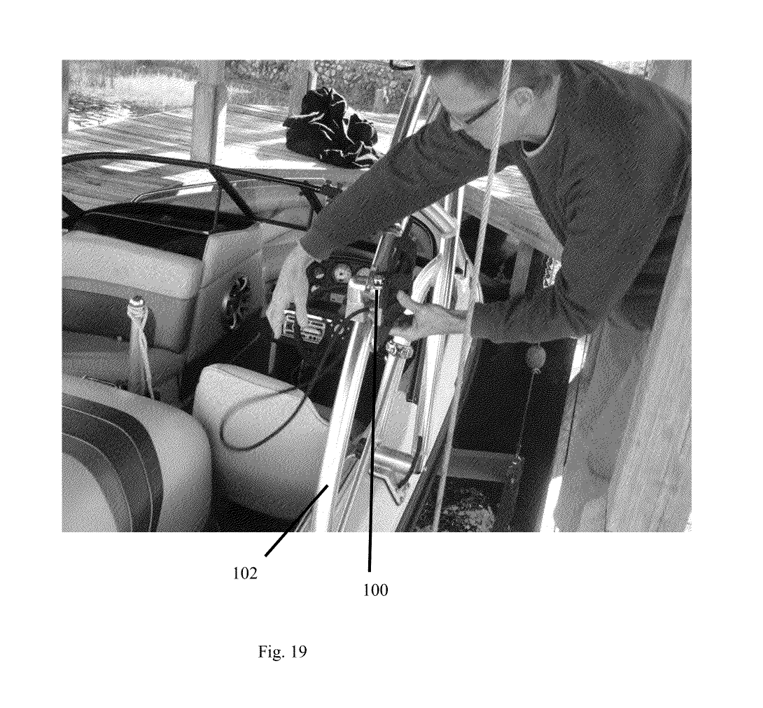

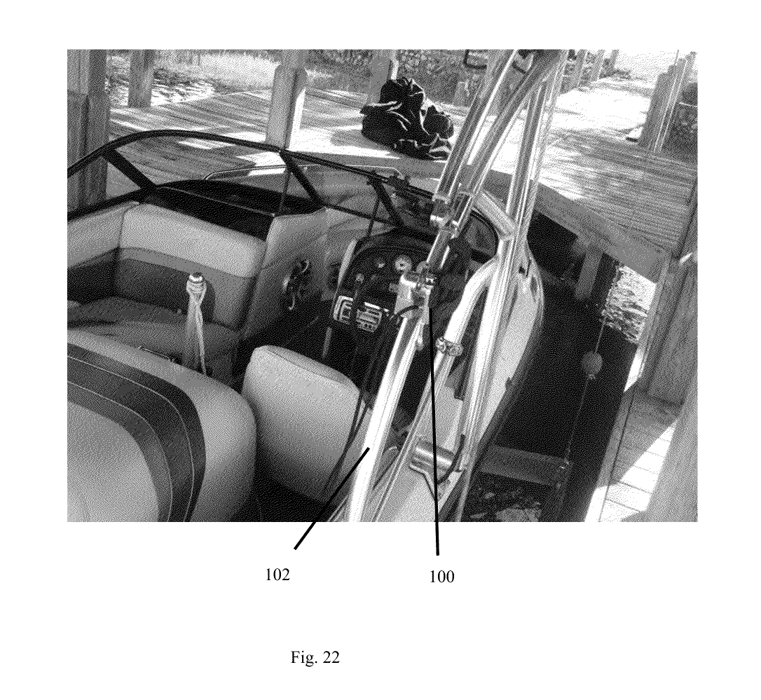

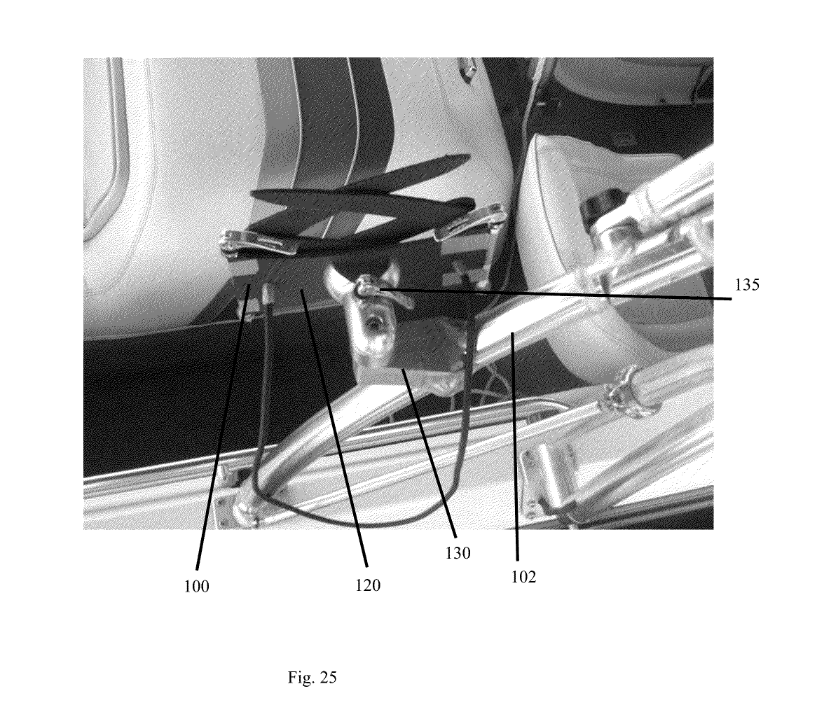

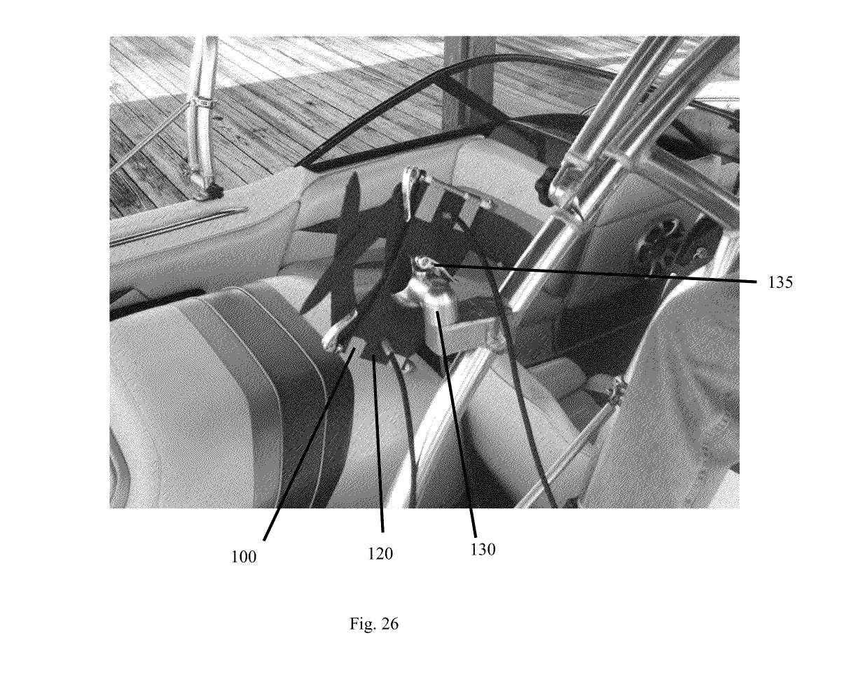

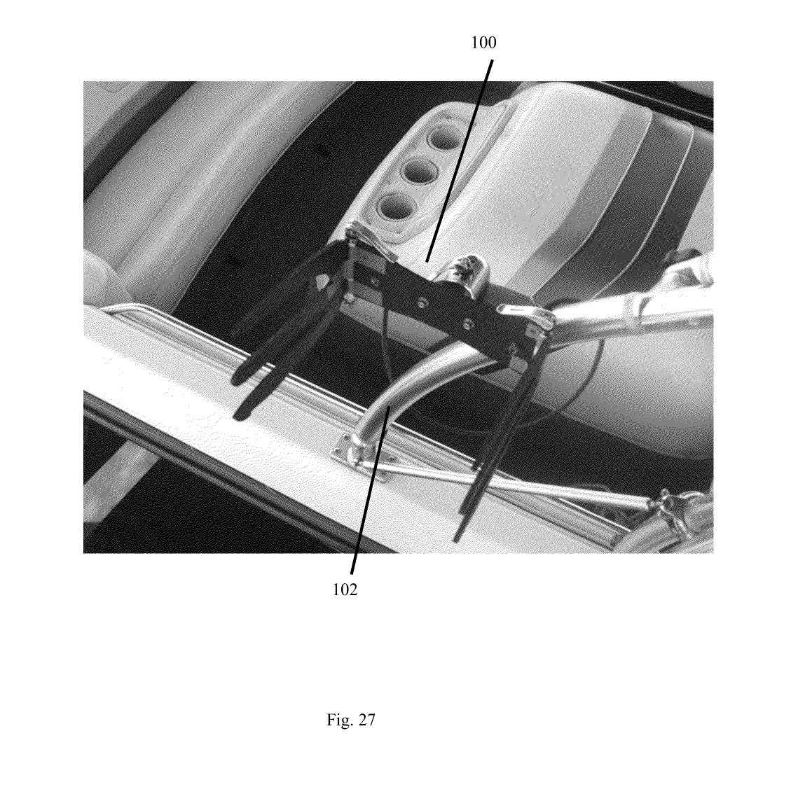

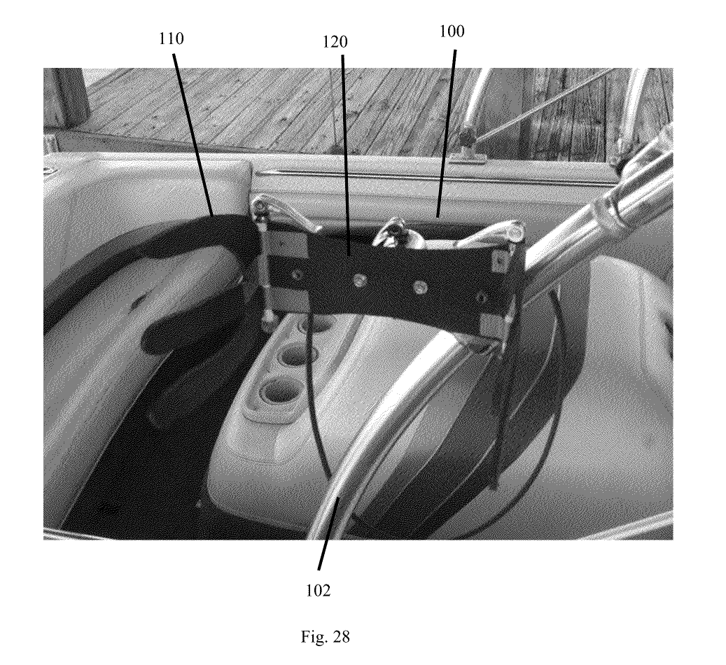

The present invention is a collapsible sports board support assembly as shown in FIG. 1-FIG. 43.

The preferred embodiment of the invention, as shown at least in FIGS. 1-10 is a collapsible sports board support assembly 100 which includes a pair of board support forks 110 hingedly interconnected by a board support base 120. The board support assembly includes a board support mount 130 which is attached to the board support base 120 for removably and pivotally mounting the collapsible sports board support assembly 100 to various structures such as boat towers, vehicles, and static supports.

In the preferred embodiment of the invention each of the board support forks 110 include at least two, most preferably three, fork prongs 115 which extend outward from the board support base 120.

Alternate board support forks 110 may include four or more board support fork prongs 115 as needed.

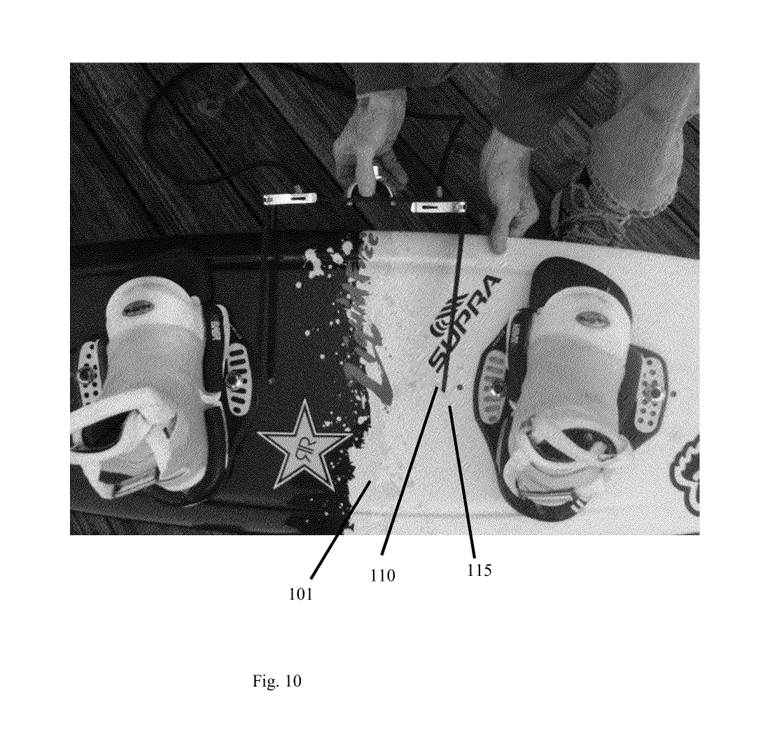

The board support fork prongs 115 extend to a distance suitable for securing the applicable sports board 101 between a pair of the fork prongs 115 as shown in FIG. 10.

Typically the length of the fork prongs 115 is approximately one-half the width of the sports board 101 which is to be supported. This allows safe and secure support of the sports board 101 while minimize the length of the fork prongs 115.

It is further envisioned that the length of the fork prongs 115 can be optimized for the type and width of sports board 101 to be supported by determining the width and weight of the sports board 101 and selecting fork prongs 115 suitable for securely holding the anticipated load.

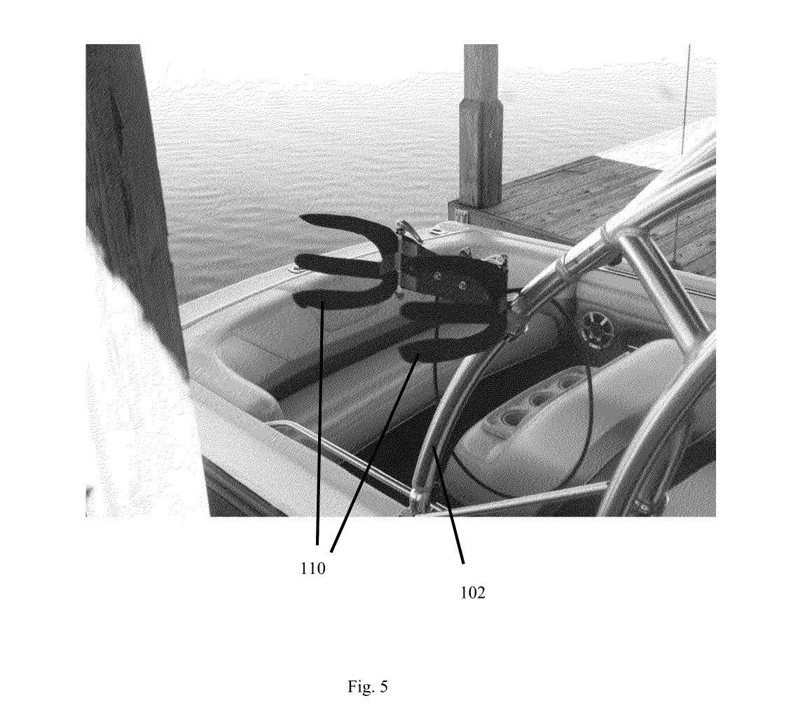

Further, as shown in FIGS. 5-7, the fork prongs 115 may be positioned at an angle to the board support base 120 thereby by shifting the center of gravity of the supported supports board 101. With the shift in the center of gravity of the supported sports board 101, the length of the fork prongs 115 are complimentarily modified to provide the appropriate support. For example if the fork prongs 115 are angled at less than 45 degrees from the board support base 120 (clockwise rotation applied) the sports board 101 center of gravity will be directed towards the board support base 120 and short the fork prongs 115 may adequately support the sports board 101.

As the fork prongs 115 are angled further away from the board support base 120 (clockwise rotation applied) the sports board 101 center of gravity will be directed further away from the board support base 120 and longer fork prongs 115 may be required to adequately support the sports board 101.

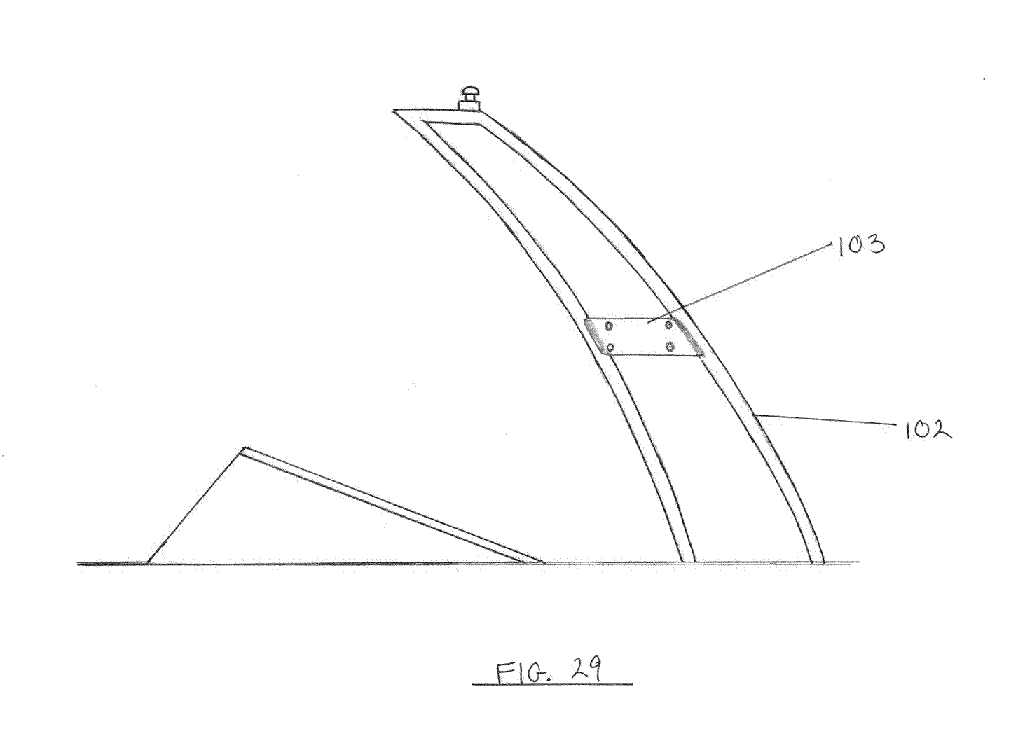

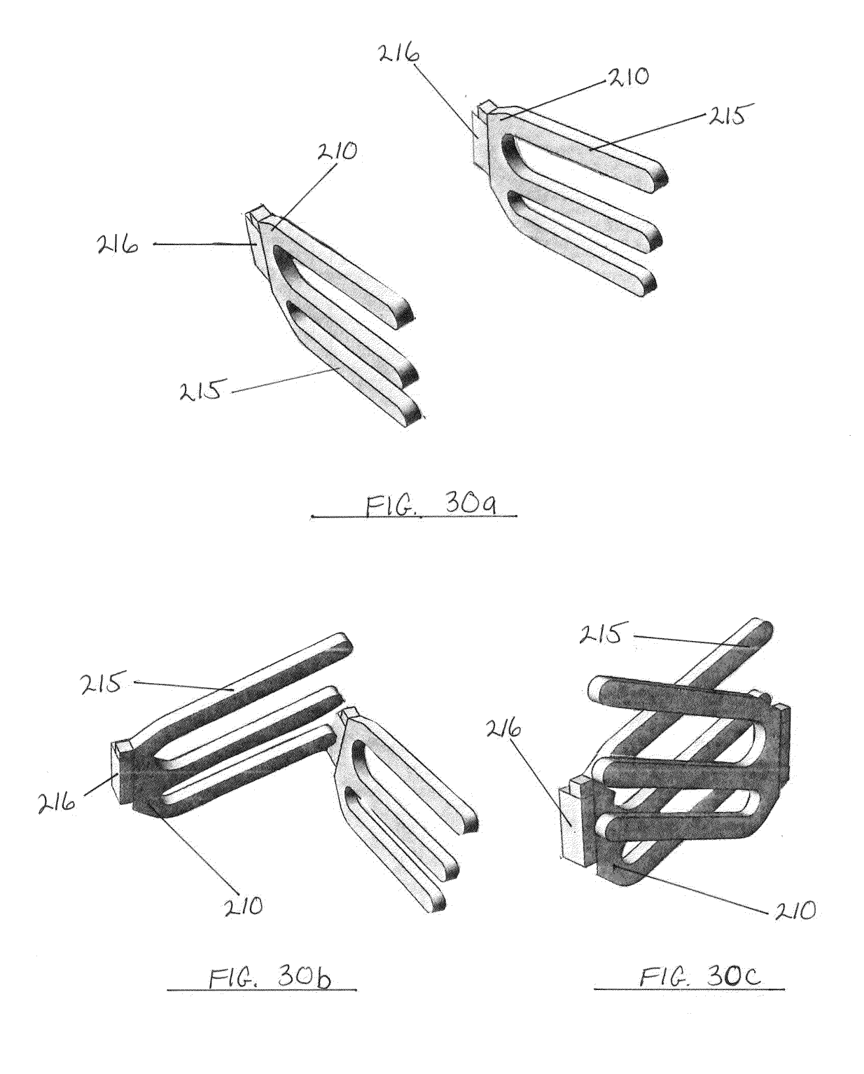

As shown in at least, FIGS. 30b and 30c, it is novel to be able to fold two board forks that are approximately 11″ in length into a space in between the board forks that is only 8.5″ in width. It requires the board fork angle to be optimized in order to utilize the space between the board forks which is limited by the distance between the bindings on a wakeboard. As the angle of the forks increases, less width between the forks is required to fold them. The angle of the forks is often a critical factor in minimizing the required width between the board forks. This space optimizing factor creates a unique functionality of the device.

Further the distance between each pair of fork prongs 115 is selected to be suitable with the anticipated thickness of the applicable sports board 101.

It is anticipated that additional structural features or elements may be provided to assist the fork prongs 115 in retaining the inserted sports board 101.

As previously stated the fork prongs 115 are hingedly attached 116 to the board support base 120 which allows the fork prongs 115 to be folded inward towards the board support base 120. The length of the fork prongs 115 will affect the ability of the forks to be folded therefore an optimized selection of the length of the fork prongs 115 with relation to the sports board 101 width is preferable.

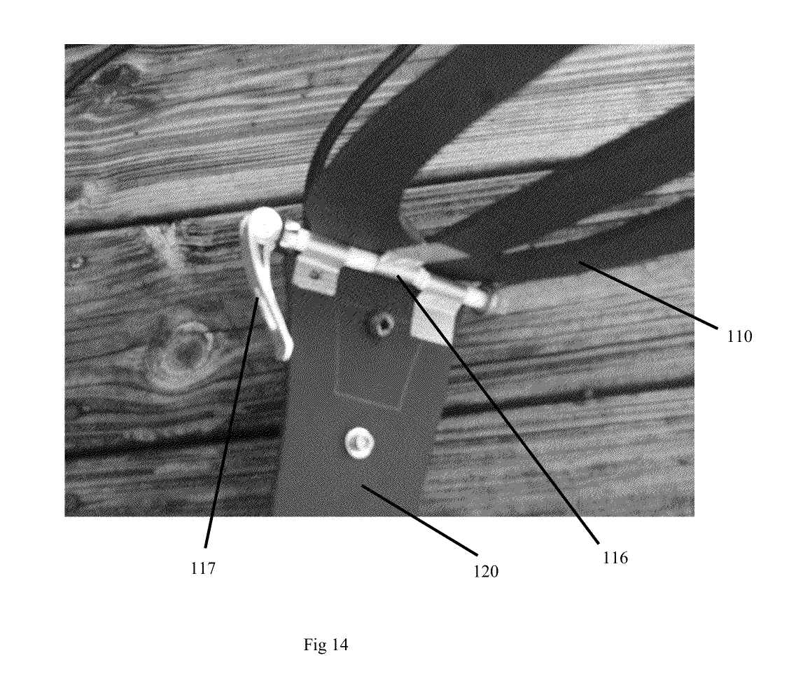

As shown in FIG. 14, the attachment hinge 116 preferably includes a fork hinge quick release handle 117 to lock or release the pivotal movement of the fork prongs 115. The fork prongs 115 and board support base 120 are hingedly attached together similar to the hinged attachment of a door to a door frame.

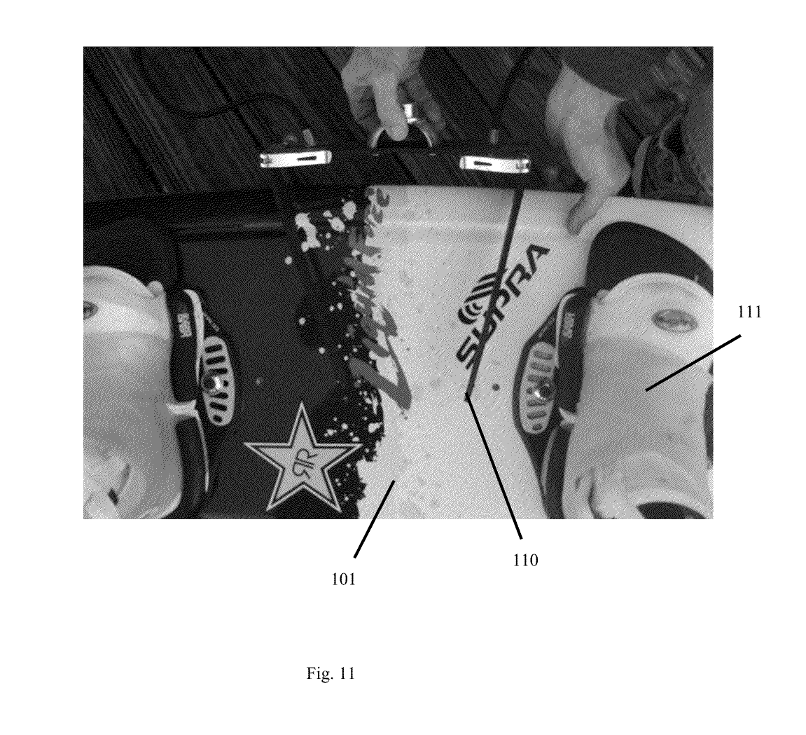

An added advantage of the foldable fork prongs 115 is that, as shown in FIG. 10 and FIG. 11, the fork prongs 115 can be pivoted to support a variety of sports board widths. This is also important because sports boarders such as ski boarders users mount boots and bindings 111 to the surface of the sports board 101 at a width approximately equal to the width of the users shoulders and the mounted boots and binders 111 can interfere with placing the sports board 101 into a board support assembly 100.

By pivoting or folding the foldable fork prongs 115 slightly to accommodate the placement of the boots and bindings 111, users can retain their preferred boot mount position. In contrast, with sports board support assemblies having rigidly attached fork prongs the users will have to remove their boots from the sports board prior to mounting the sports board onto the sports board support assembly and then re-install the boots onto the sports board assembly when the users want to use the sports board 101.

With the sports board 101 placed into the sports board support assembly 100, a board securing cord 118, such as a bungee cord, can be used to further secure the sports board to the sports board support assembly 100.

The entire collapsible sports board support assembly 100 is removably and pivotally mounted onto a support structure 102 such as boat towers, vehicles, and static supports via board support base 120 and base support mount 130.

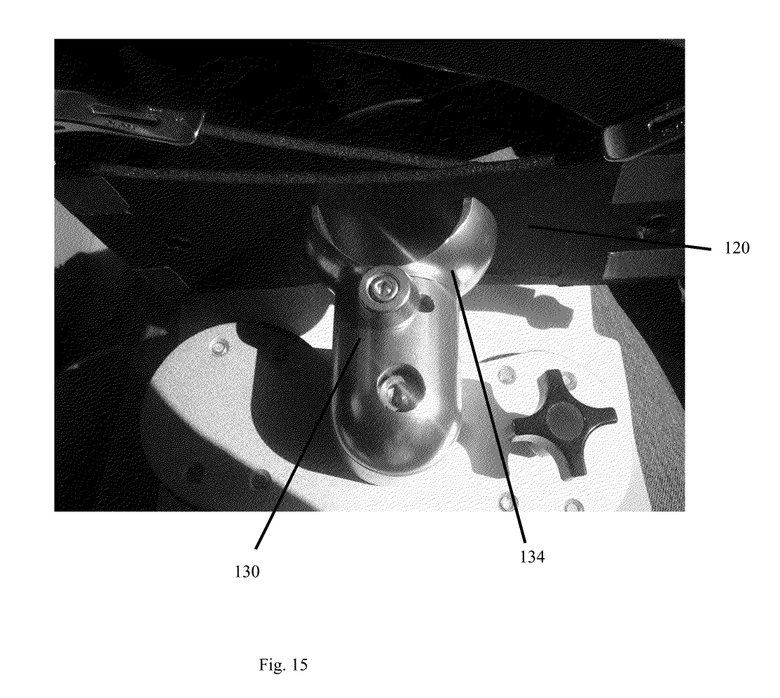

The board support base mount 130 includes a rotational section 134 which locks into position via a support base mount quick release handle 135, and support base mount quick release bolt 136 as shown at least in FIGS. 15-18 and FIGS. 25-26. Locking the support base mount quick release handle 135 prevents the rotation of the rotational section 134 and thereby prevents the sports board support assembly 100 from rotation in a clockwise or counter-clockwise direction. Releasing the lock allows free rotation of the board support base 120.

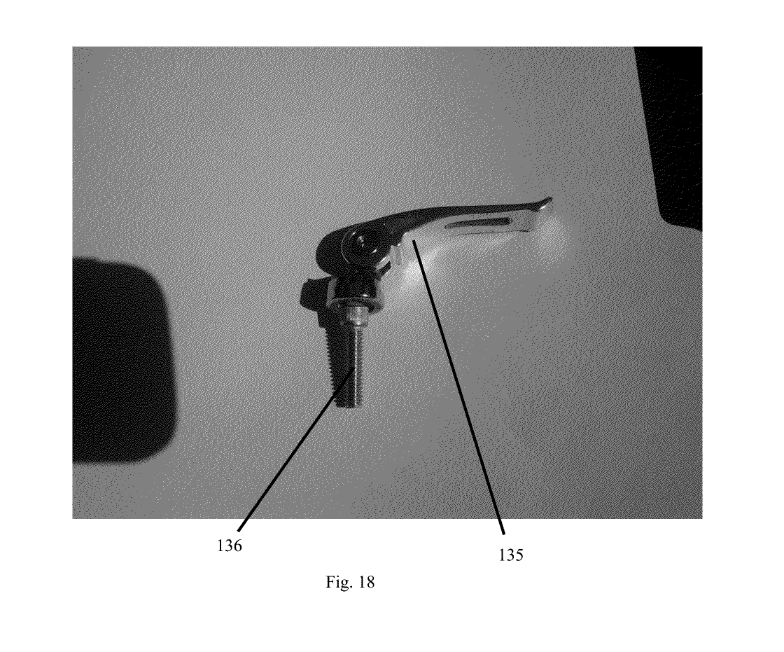

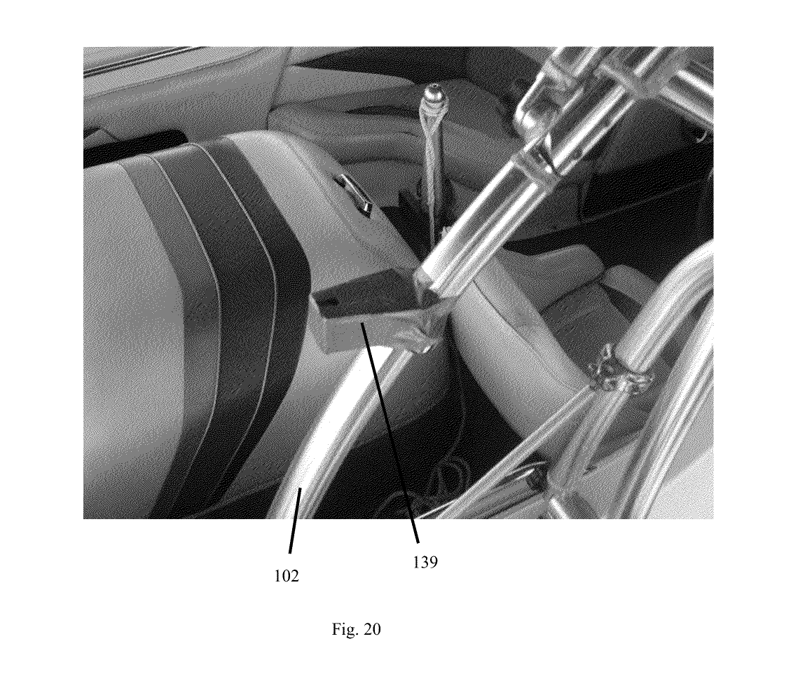

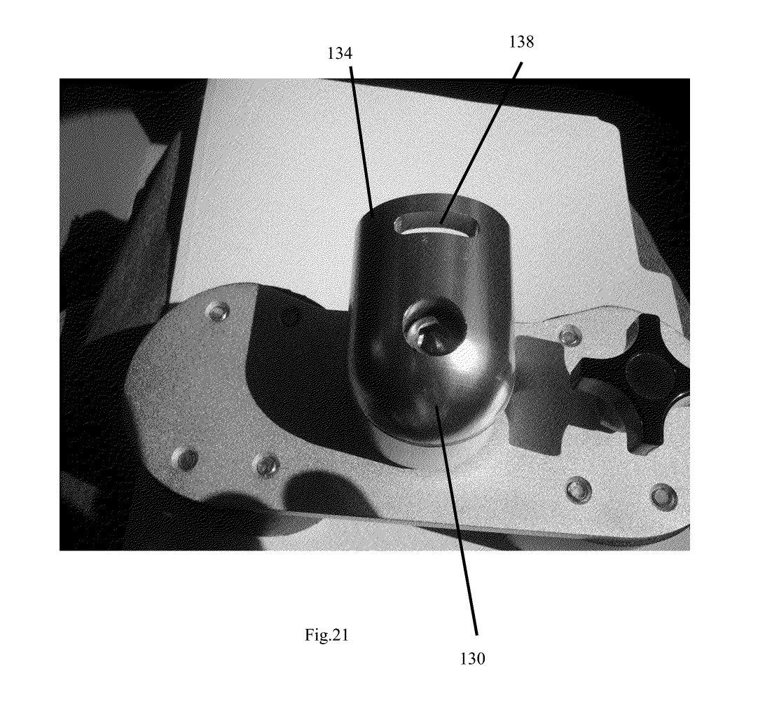

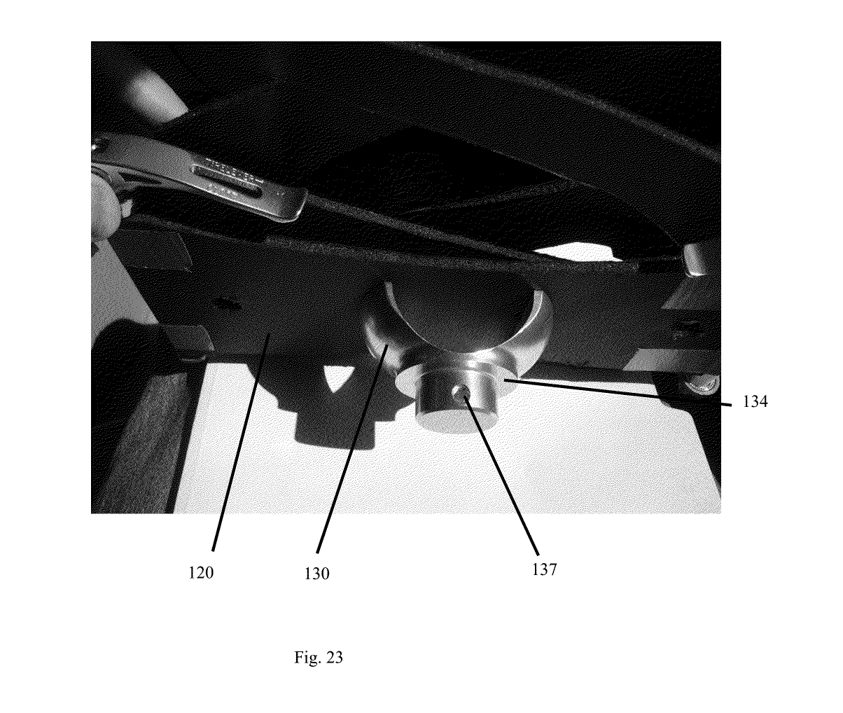

As shown in at least in FIGS. 21 and FIG. 23, the board support base mount rotational section 134 includes an aperture 137 and a companion slot 138 thru which the support base mount quick release bolt 136 (see FIG. 18) and extends when inserted to prevent or allow rotation of the board support base 120.

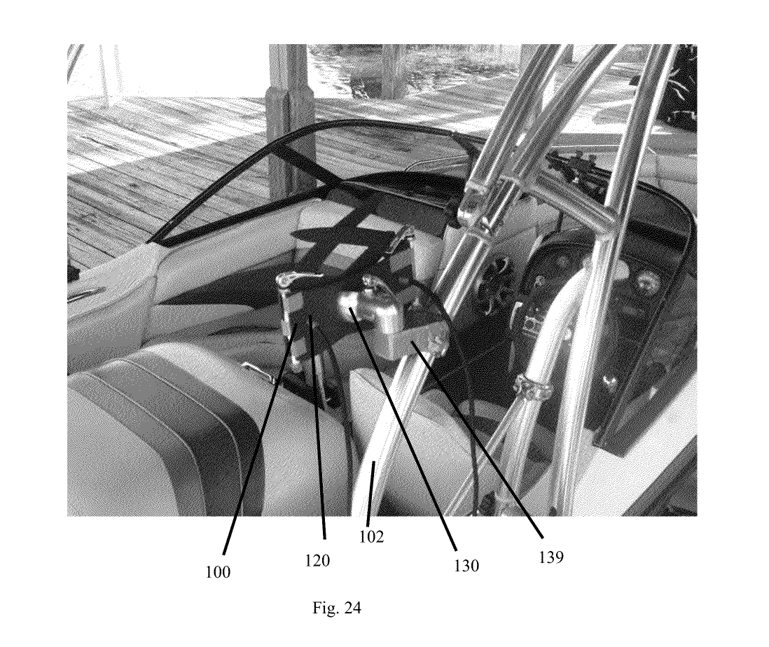

The base support mount 130 may be attached directly to the support structure 102 or, as shown in FIGS. 20 and 24, the base support mount 130 may be positioned on a supplemental base support mount holder 139, which is attached to the applicable support structure 102. The base support holder mount 139 may be and independent mounting element or a section of the support structure 102 (such as a boat tower) which includes mounting deformations (not shown) designed to allow the board support base 120 to be positioned substantially flush with the support structure 102.

Whether the base support mount 130 is attached directly to the support structure 102 or to a supplemental base support mount holder 139, a removable base support mount securing pin 130a is used to further secure the base support mount 130 to the applicable structure. The purpose of the support mount securing pin 130a is to affect (prevent or allow) rotation of the base support mount on the supporting structure 102 or on the supplemental base support mount holder 139. The removable base support mount securing pin 130a may be provided as a quick release mechanism having a quick release handle or as a completely removable pin.

The combination of the ability to rotate the board support base 120 and the base support mount 130, as well as the ability to fold the fork prongs 115 allows the sports board support assembly 100 to be nearly infinitely repositionable and adjustable and therefore the collapsible sports board support assembly 100 of the instant invention is uniquely compatible with adjustable support structures 102 such as height adjustable towers which change angles as the tower is raised or lowered as taught in U.S. Pat. No. 8,297,484.

As an alternative embodiment as shown in at least in FIGS. 29 through 31, the board forks 210 and hinges 216 may be mounted directly to an integrated support base 103 as a part of a support structure 102 as a cost reduction method.

Note the gunwale 140 is considered a part of the boat deck. As shown in FIG. 29 the support structure 102 may comprise multiple support structures 102 attached to the boat deck along the same port or starboard gunwale 140.

An additional alternative embodiment (not shown) incorporates a drive mechanism to actuate the folding and unfolding of the board forks 110. Various methods such as cable gears, actuated struts, or motor-driven gears may be used to move the board forks for ease of use to the user.

A further embodiment of the quick release feature of the collapsible sports board support assembly 100 of the instant invention is provided in FIG. 32-43 where, inter alia, the repositioning of the entire board support assembly 100 and/or the forks 115 can easily be accomplished. Typically the forks 110 are repositioned between a folded position and an unfolded position and the collapsible sports board support assembly 100 is rotated or pivoted as needed for use or for storage.

As previously stated the fork prongs 115 are hingedly attached 116 to the board support base 120 which allows the fork prongs 115 to be folded inward towards the board support base 120.

As shown at least in FIGS. 32 - 43, each attachment hinge 116 preferably includes a fork hinge having at least one single quick release mechanism 150 to lock or release the pivotal movement of the fork 110. The fork 110 and board support base 120 are hingedly attached together similar to the hinged attachment of a door to a door frame. The attachment hinge 116 may include multiple quick release mechanisms 150 connecting together the board support base 120 and the fork 110. The board support base 120 includes a pair of ears 121, each positioned at a distal end of the support base 120.

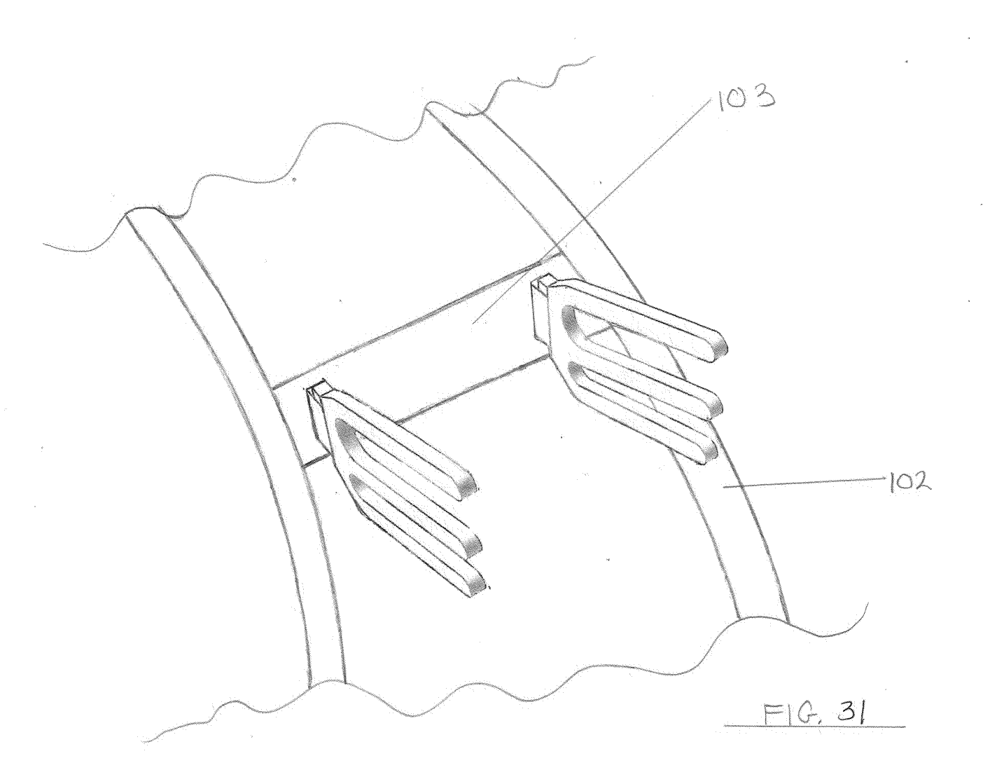

As shown in at least FIG. 34-36, the support base ears 121 may be of unequal length. The unequal length ears 121 allow one fork 110 and its prongs to rest on top of or adjacent to the other fork 110 and its prongs as shown in FIG. 36 and FIG. 42. This compact space minimizing configuration is achieved by the off-set of the fork folding axis 160 of each fork 110 where each fork folding axis 160 is a different distance from the support base 120. In the off-set folding axis 160 arrangement, the fork 110 closest to the support base 120 can be folded against the support base 120 and the other fork 110 is then folded down against that fork 110, which is not possible where the forks 110 both pivot around the same folding axis.

As shown at least in FIG. 32-37, one embodiment of a single quick release mechanism 150 includes a spring plunger 155, provided on the fork 110, which releasably secures the fork 110 in a proscribed position on the support base 120. The spring plunger ball 155a seats in a position hole 122 provided on an ear 121 of the support base 120. The support base ear 121 includes at least one position hole 122 and preferably includes at least a position hole for securing the forks 110 in the unfolded position and a position hole for securing the forks 110 in a folded position. To fold or unfold the forks 110, the user simply applies a force to the forks 110 to unseat the spring plunger ball 155a from the applicable position hole 122 and rotates the fork 110 until the spring plunger ball 155a seats in the desired position hole 122.

As shown in FIG. 33, each fork 110 rotates about its own folding axis 160. Each fork 110 includes at least one fork fold protrusion 112 and preferably includes a second fork fold protrusion 114. It is noted that the fork 110 may include additional fork fold protrusions, for example to provide addition weight bearing strength to the fork 110. The spring plunger 155 quick release mechanism 150 is positioned on the fork fold protrusion 112 as shown in FIG. 33 and, as previously explained, the spring plunger ball 155a seats in a position hole 122 provided on an ear 121 of the support base 120. Each fork 110 is connected to the support base 120 via at least one pivoting pin 160a which extends thru the folding axis 160. While at least one fork fold protrusion includes a pivoting pin 160a connecting the fork 110 to the support base 120, not all fork fold protrusions are required to include a pin.

FIG. 35 shows a single fork 110 positioned in the folded position wherein the fork has been rotated about the folding axis 160 and the spring plunger ball 155a has seated in the applicable folded position hole 122.

FIG. 36 shows both forks 110 positioned in the folded position wherein the forks has been rotated about the folding axis 160 and the spring plunger ball 155a has seated in the applicable folded position hole 122. In this position it is observed that the forks 110 occupy a minimal amount of space.

As shown in FIG. 37 the ear 121 of the support base 120 at the folding axis 160 is of similar shape to the fork fold protrusion 112. While these shapes may be similar or different, the alignment of the spring plunger 155 with at least one position hole 122 is retained so that the spring plunger ball 155a can be seated in the appropriate position hole 122 provided on an ear 121 of the support base 120.

As shown at least in FIGS. 32-36, 38, 39 and 43, a spline 170 is provided between the support base 120 and the base support mount 130. A spline first portion 170a is provided on the support base 120 and a spline second portion 170b is provided on the base support mount 130. Contact between the spline portions 170a and 170b prevents or inhibits rotation of the support base 120 about the base support mount 130. The spline first portion 170a includes a contact face 171a and the spline second portion 170b includes a contact face 171b. The contact faces 171a, 171b may be of complimentary design or each contact face may have its own unique design. As shown in at least in FIGS. 32-36, 38, 39 and 43 the contact faces 171a, 171b have complimentary ridge shapes such that when these ridge faces are in contact with each other the rotation of the support base 120 about the base support mount 130 is prevented or inhibited.

The distance between contact faces 171a, 171b is adjusted by the spline lock 173 provided on the support base as shown in FIG. 40. The spline lock can be of any suitable design such as a lever 173a, wing nut (not shown), threaded bolt (not shown), or knob (not shown). Unlocking the spline lock 173 allows for rotation of the support base 120 about the base support mount 130 and locking the spline lock 173 prevents or inhibits rotation of the support base 120 about the base support mount 130 prevents or inhibits rotation of the support base 120 about the base support mount 130.

As shown at least in FIG. 39-41, the spline first portion 170a and the spline second portion 170b are aligned along a common spline lock axis 172. On the support base 120 the spline lock axis 172 is preferably positioned off-center from the front 120a of the support base 120. This off-center positioning of the spline lock axis 172 minimizes the protrusion of the collapsible sports board support assembly 100 when the assembly 100 is mounted on a support structure 102 which is folded down towards a support surface 102a. For example if the collapsible sports board support assembly 100 is attached to a support structure 102 such a boat tower and the applicable support surface is a boat gunwale, when the boat tower is folded down towards the boat gunwale, the off-center position of the spline lock axis 172 of the collapsible sports board support assembly 100 would minimize the portions of the assembly 100 which are higher than the support structure 102. This is particularly useful when a boats is covered (such as during transporting, storage, or maintenance) because the low profile configuration of the instant assembly 100 does not stick up through the boat cover and allows boaters to use their existing boat covers.

The base support mount 130 (which rotates about a mount axis 200 on mounting bolt 201) providing the spline second portion 170b may be attached directly to the support structure 102 as shown in FIG. 41 or, as previously discussed; the base support mount 130 may be positioned on a supplemental base support mount holder 139, which is attached to the applicable support structure 102. The base support holder mount 139 may be and independent mounting element or a section of the support structure 102 (such as a boat tower) which includes mounting deformations (not shown) designed to allow the board support base 120 to be positioned substantially flush with the support structure 102.

As shown at least in FIG. 42, an embodiment of a single quick release mechanism 150 includes a surface lock mechanism 180 connecting a surface of the fork prongs 115 to a surface of the support base 120 or to a surface of other fork prongs 115. Fastening elements such a magnetic disk 180a or a patch of hook and loop fasteners 180b can be positioned on the appropriate support base 120 and/or appropriate surface of other fork prongs 115 to hold the applicable fork 110 in place. To unfold the fork 110, the user simply applies a force to rotate the fork 110 about the folding axis 160 to unseat mated surface lock mechanism 180 and further rotates the fork 100 until it is in the desired position. Similarly, to secure the forks 110 the user rotates the fork 110 about the folding axis 160 until the applicable surface lock mechanism 180 element on the fork 110 mates with the surface lock mechanism 180 element on the support base 120.

As shown at least in FIG. 43, an embodiment of a single quick release mechanism 150 is the sprung bolt mechanism 190 which includes a bolt 191, a spring 192 positioned at a distal end of the bolt 191, a nut 193 retaining the spring 192 on the bolt 191, a position pin 194 extending from the fork fold protrusion 112, and a position hole 122 provided on an ear 121 of the support base 120. Note, the bolt 191, spring 192 positioned at a distal end of the bolt 191, nut 193 retaining the spring 192 on the bolt 191 may be used to hold the fork fold protrusion 112 against an ear 121 of the support base 120 without the inclusion of the position pin 194 as shown in FIG. 43.

In operation the position pin 194 is used to locate the fork 110 in the selected position (folded, unfolded, or an intermediary position) and the spring 192 and bolt 191 combination provides the holding force to keep the fork 110 in the selected position. To adjust the selected position of the fork 110 the user lifts up on the fork 110 which compresses the spring 192 and allows the fork 110 to be rotated about the folding axis 160. Once the fork 110 is in the selected position and the position pin 194 is aligned with the position hole 122 provided on an ear 121 of the support base 120, the user releases the fork 110 and the spring 192 positioned on bolt 191 expands and provides the holding force to keep the fork 110 in the selected position.

As previously discussed the support base ear 121 may include a single position hole 122 or a plurality of position holes 122 thereby allowing the user to adjustably select the position of the fork 110 in relation to the support base 120.

Rotation of the base support mount 130 about mount axis 200 on mounting bolt 201 provides for rotation of the collapsible sports board support assembly 100 independent of the folding and unfolding of the forks 110.

Further, the support structures discussed herein are not considered an exhaustive list of support structures and it is anticipated the instant invention is useable with a variety of support structures 102 such as support assemblies on vehicles as well as support assemblies for mounting sports equipment to walls or other non-mobile structures.

It is understood the components of the instant invention are constructed from materials suitable to the applicable usage environment.

While various embodiments of the present invention may be shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A quick release collapsible sports board support assembly for removable attachment to a support structure comprising:
a plurality of foldable board support forks hingedly attached to a support base, each fork having prongs extending away from the support base,
wherein the hinged attachment is provided by a single quick release handle interleaving the fork and the support base,
wherein the plurality of foldable support forks are folded onto the support base to minimize the space occupied by the assembly.

2. The quick release collapsible sports board support assembly of claim 1 wherein the support base is rotatable.

3. The quick release collapsible sports board support assembly of claim 1 wherein the support base is pivotable.

4. A quick release collapsible sports board support assembly for removable attachment to a support structure comprising:
a plurality of foldable board support forks hingedly attached to the support base, each fork having prongs extending away from the support base,
wherein the hinged attached fork are aligned in an of off-set configuration to allow the forks to fold on top of or adjacent each other, and
wherein the plurality of foldable support forks are folded onto the support base to minimize the space occupied by the assembly.

5. The quick release collapsible sports board support assembly of claim 4 wherein the support base is rotatable.

6. The quick release collapsible sports board support assembly of claim 5 wherein rotation of the support base is provided by a pair of spline halves,
wherein one spline half is provided on the support base and a complementary spline half is provided on a board support mount.

7. The quick release collapsible sports board support assembly of claim 4 wherein the support base is pivotable.

8. A quick release collapsible sports board support assembly for removable attachment to a support structure comprising:
a plurality of foldable board support forks hingedly attached to a support base, each fork having prongs extending away from the support base,
wherein the hinged attachment is provided by a single quick release mechanism operating between the fork and the support base,
wherein the plurality of foldable support forks are folded onto the support base to minimize the space occupied by the assembly.

9. The quick release collapsible sports board support assembly of claim 8 wherein the support base is rotatable.

10. The quick release collapsible sports board support assembly of claim 9 wherein rotation of the support base is provided by a pair of spline halves,
wherein one spline half is provided on the support base and a complementary spline half is provided on a board support mount.

11. The quick release collapsible sports board support assembly of claim 8 wherein the support base is pivotable.

12. The quick release collapsible sports board support assembly of claim 8 wherein the single quick release mechanism includes a spring plunger which releasably secures the fork in a proscribed position on the support base.

13. The quick release collapsible sports board support assembly of claim 8 wherein the single quick release mechanism includes a surface lock mechanism which releasably secures the fork in a proscribed position on the support base.

14. The quick release collapsible sports board support assembly of claim 8 wherein the single quick release mechanism includes a sprung bolt mechanism which releasably secures the fork in a proscribed position on the support base.

15. The quick release collapsible sports board support assembly of claim 8 wherein the hinged attached fork are aligned in an off-set configuration to allow the forks to fold on top of or adjacent each other.
